(19) United States
(12) Patent Application Publication
(10) Pub. No.: US 2019/0031043 A1
(43) Pub. Date: Jan. 31, 2019

(54) INTERLEAVED CONVERTER POWER SYSTEM

(71) Applicant: GM GLOBAL TECHNOLOGY OPERATIONS LLC, Detroit, MI (US)

(72) Inventors: Ahmad Albanna, Dearborn Heights, MI (US); Mohammad N. Anwar, Van Buren Township, MI (US); Brendan M. Conlon, Rochester Hills, MI (US)

(73) Assignee: GM GLOBAL TECHNOLOGY OPERATIONS LLC, Detroit, MI (US)

(21) Appl. No.: 15/659,310

(22) Filed: Jul. 25, 2017

(51) Int. Cl. B60L 11/18; H02M 3/22

(52) U.S. Cl. CPC B60L 11/1868; B60L 2210/10; H02M 3/22

(57) ABSTRACT

A power system is configured to deliver direct current (DC) electric power to an energy storage system (ESS) at a first voltage and to deliver DC electric power from the ESS at a second voltage. A converter is coupled to an electric power source at the second voltage. The converter includes a boost converter and a buck converter. The boost converter and the buck converter are configurable in a first interleaved arrangement and in a second interleaved arrangement, different than the first interleaved arrangement. In the first interleaved arrangement the converter provides DC electric power from the power source to the ESS at the first voltage, and in the second interleaved arrangement the converter provides DC electric power from the ESS to the power source at the second voltage.

### TECHNICAL FIELD

This patent generally relates to mobile power systems, and more particularly relates to a power system incorporating interleaved converters.

### BACKGROUND

An energy storage system (ESS), such as a battery system, in a mobile application requires a convenient approach to reversing the depletion of the ESS and an efficient coupling of the ESS to a propulsion unit. The depleted ESS, or a rechargeable part thereof, may be physically exchanged with a charged unit. Exchange requires availability of compatible battery packs and a system designed to accommodate exchange, and using this option may be logistically challenging for more complex systems. Another option may involve the use of an offboard system where the principle components of the charging system are offboard. This type of approach may use charging stations or other types of charging facilities. An offboard charging system requires operable connection to the mobile unit, and therefore compatibility is required. Another option may be an onboard system where the principle components of the charging system are carried with the mobile unit. With onboard chargers, the principle charger components are part of each individual mobile unit, rather than being located at an offboard station that supplies power through a plug-in connection.

The onboard systems use power electronic components to couple and condition power from a power source to the ESS. The power source may be a coupled external source or an onboard generating source. In use, a separate set of onboard power electronic components operably couple the ESS to energize a propulsion unit. The power electronics in each case are large, heavy and may require cooling to operate efficiently.

Accordingly, it is desirable to provide systems and techniques for providing charging energy to and propulsion energy from an ESS. It is also desirable to provide methods, systems, and vehicles utilizing such techniques. Furthermore, other desirable features and characteristics of charging systems will be apparent from the subsequent detailed description and the appended claims, taken in conjunction with the accompanying drawings and the foregoing technical field and introduction.

### SUMMARY

In an exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage. The boost converter and the buck converter each include an inductor and a semiconductor switch.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage. The at least one switch is a semiconductor switch.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage. A second converter is operably disposed between the power source and the converter. The second converter has a DC electric output at the second voltage.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage. The power source is an alternating current (AC) electric power source.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage. A link capacitor is disposed between the converter and the second converter.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage. The propulsion system includes at least one electric motor being coupled to the link capacitor.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage. The converter includes a plurality of boost converters and a plurality of buck converters, the plurality of boost and buck converters are configurable into the first interleaved arrangement and the second interleaved arrangement.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a load at the second voltage. The first voltage is less than the second voltage. In the first interleaved arrangement a stepped down voltage is provided from the power source to the ESS, and in the second interleaved arrangement a stepped up voltage is provided from the ESS to the load.

In an another exemplary embodiment, a power system is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to provide driving electric power to an electric propulsion system of a vehicle.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a load at the second voltage.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a propulsion system of the vehicle at the second voltage. The ESS is a battery storage system disposed on the vehicle.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the propulsion system, which includes at least one electric motor.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a propulsion system of the vehicle. Each of the boost converter and the buck converter includes an inductor and a semiconductor switch.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a propulsion system of the vehicle at the second voltage. The at least one switch comprises a semiconductor switch.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a propulsion system of the vehicle at the second voltage. A second converter is disposed between the power source and the converter. The second converter has a DC electric output at the second voltage.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a propulsion system of the vehicle at the second voltage. The power source is an alternating current (AC) electric power source.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a propulsion system of the vehicle at the second voltage. The propulsion system is coupled between the converter and the second converter.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to a propulsion system of the vehicle at the second voltage. The converter is a plurality of boost converters and a plurality of buck converters, The plurality of boost and buck converters are configurable into the first interleaved arrangement and the second interleaved arrangement.

In an another exemplary embodiment, a vehicle includes a power system that is configured to deliver direct current (DC) electric power to an energy storage system (ESS) at a first voltage and to deliver DC electric power from the ESS at a second voltage, different than the first voltage. The system includes a converter operably coupled to an electric power source at the second voltage. The converter includes a boost converter and a buck converter. The boost converter and the buck converter are configurable in a first interleaved arrangement via at least one switch associated with the boost converter and the buck converter, and in a second interleaved arrangement, different than the first interleaved arrangement, via the at least one switch. In the first interleaved arrangement the converter provides DC electric power from the power source to the ESS at the first voltage, and in the second interleaved arrangement the converter provides DC electric power from the ESS to the power source at the second voltage. The first voltage is less than the second voltage. The first interleaved arrangement provides a stepped down voltage from the power source to the ESS, and the second interleaved arrangement provides a stepped up voltage from the ESS to a propulsion system of the vehicle.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of an electrified vehicle that includes a power system, in accordance with exemplary embodiments; and

FIG. 2 is a block diagram of power system aspects shown with the electrified vehicle of FIG. 1, according to herein described exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term system or module may refer to any combination or collection of mechanical and electrical hardware, software, firmware, electronic control component, processing logic, and/or processor device, individually or in any combination, including without limitation: application specific integrated circuit (ASIC), an electronic circuit, a processor (shared, dedicated, or group) that executes one or more software or firmware programs, memory to contain software or firmware instructions, a combinational logic circuit, and/or other suitable components that provide the described functionality.

Exemplary embodiments may be described herein in terms of functional and/or logical block components and various processing steps. It should be appreciated that such block components may be realized by any number, combination or collection of mechanical and electrical hardware, software, and/or firmware components configured to perform the specified functions. For example, an embodiment of the invention may employ various combinations of mechanical components and electrical components, integrated circuit components, memory elements, digital signal processing elements, logic elements, look-up tables, or the like, which may carry out a variety of functions under the control of one or more microprocessors or other control devices. In addition, those skilled in the art will appreciate that the exemplary embodiments may be practiced in conjunction with any number of mechanical and/or electronic systems, and that the vehicle systems described herein are merely exemplary embodiment of possible implementations.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

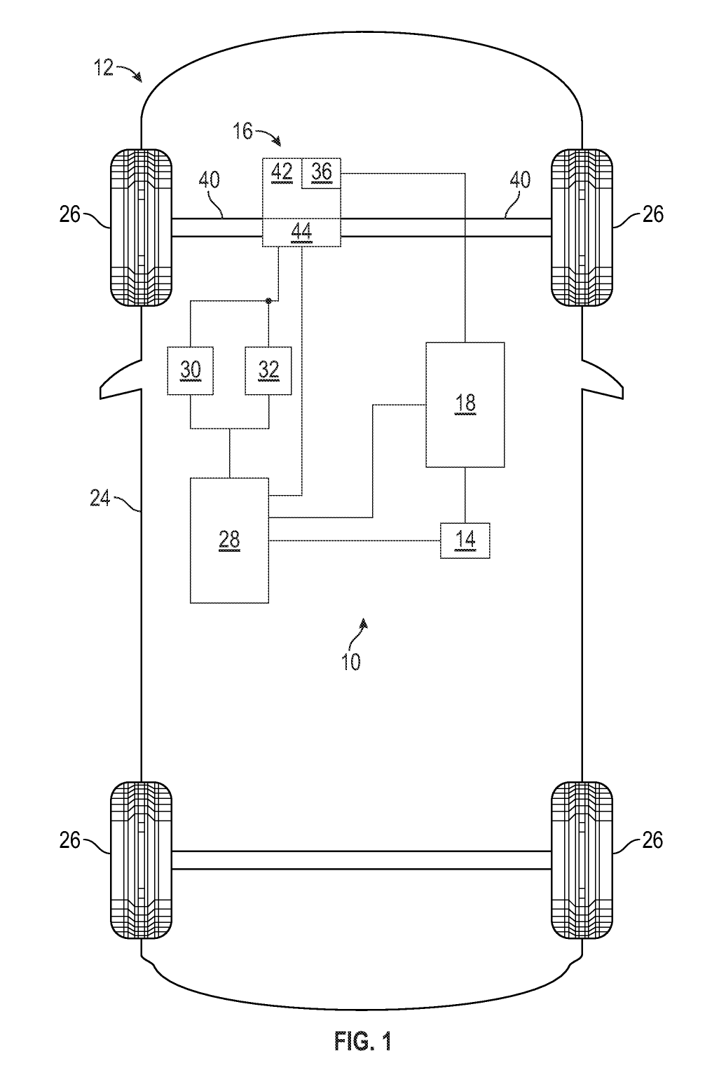

In accordance with herein describe exemplary embodiments, a power system 10 may be employed in a mobile unit, such as a vehicle 12 depicted in FIG. 1, that uses an ESS 14, for which charging may be needed, and a propulsion system 16 responsive to a supply of energizing power, for example from the ESS 14. The vehicle 12 may be any one of a number of different types of land, sea, or air vehicles, and in certain embodiments, may for example, be a passenger automobile of any configuration. As depicted in FIG. 1, the vehicle 12 may include, in addition to the above-referenced power system 10, ESS 14 and propulsion system 16, any, or any combination of: a body 24, wheels 26, an electronic control system 28, a steering system 30, and a braking system 32. The wheels 26 may each be rotationally coupled to the body 24. In various embodiments the vehicle 12 may differ from that depicted in FIG. 1. For example, in certain embodiments the number of wheels 26 may vary. By way of additional examples, in various embodiments the vehicle 12 may not have wheels 26 that react against a roadway, but may include another method of converting torque into motion, for example, through pitched blades operating against a fluid.

In the example illustrated in FIG. 1, the vehicle 12 includes at least one propulsion system 16, which in these examples may drive the wheels 26. The propulsion system 16 may include an engine 42 and/or an electric machine, which may include a device such as a motor 36. With inclusion of the motor 36, the vehicle 12 is an electrified vehicle. In a number of examples, the motor 36 may be an electric motor-generator and/or may be more than one motor. The motor 36 may be powered via the ESS 14 or by one or more additional power sources through the power system 10. In exemplary embodiments the ESS 14 may be a battery or batteries.

The propulsion system 16 may include the combustion engine 42, such as in a hybrid arrangement with the motor 36, or in another alternative configuration. In a number of examples, the electronic control system 28 may include variations of components or modules that may be packaged together, or distributed to various locations of the vehicle 12. In a number of examples, the electronic control system 28 may include an engine control module, a body control module, a transmission control module, a battery management system, a vehicle integration control module, and/or one or more other components to control a system, function or operation, of the vehicle 12. The propulsion system 16 may be coupled to at least some of the wheels 26 through one or more drive shafts 40. In some examples, the propulsion system 16 may include the engine 42 and/or a transmission 44 to provide variable output. In a number of examples, the motor 36 may be coupled to the transmission 44. In other examples, the engine 42 and/or transmission 44 may not be necessary, and may be omitted.

In the examples illustrated in FIG. 1, the steering system 30 may control the direction of at least some of the wheels 26. In certain embodiments, the vehicle 12 may be autonomous, utilizing steering commands that are generated by a processor, such as in the electronic control system 28. The braking system 32 may provide braking for the vehicle 12. The braking system 32 may receive inputs from a driver via a brake pedal (not shown), which may control vehicle deceleration through wheel brakes (not shown) and/or as may be effected via operation of the motor 36 in a regenerative mode. An operator may also provide inputs via an accelerator pedal (not shown) to command a desired speed or acceleration of the vehicle 12. Response of the vehicle 12 to these inputs may be effected, at least in part, through an output speed and/or torque of the motor 36. Similar to the description above regarding possible variations for the vehicle 12, in certain embodiments steering, braking, and/or acceleration may be commanded by a computer instead of by a driver, such as through an autonomous capability.

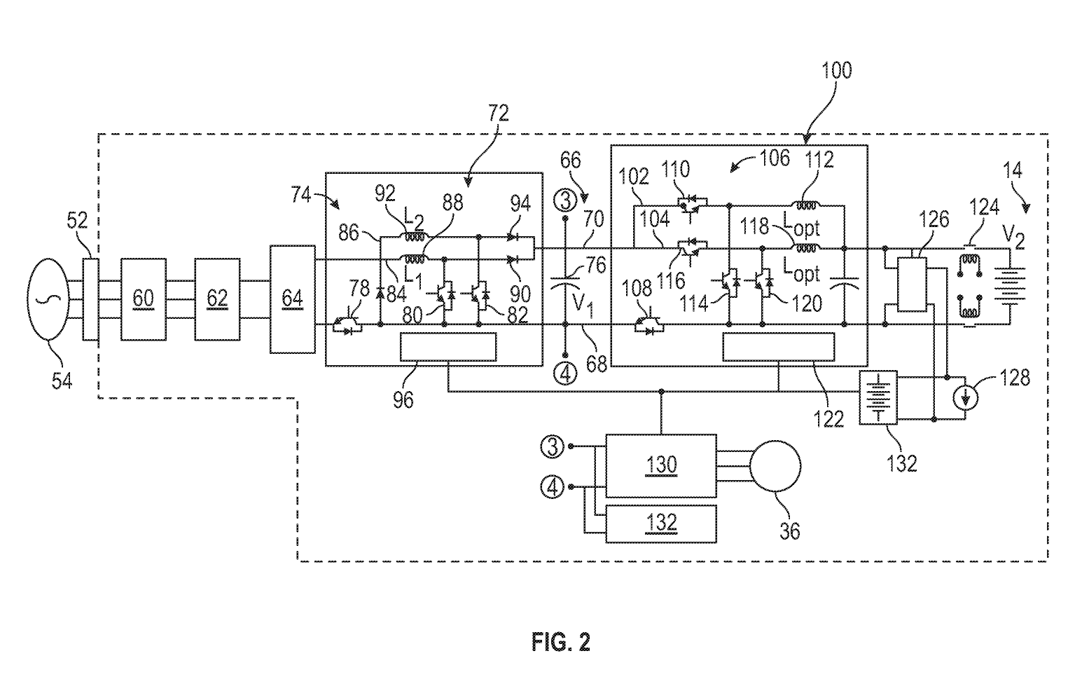

With reference to FIG. 2, in accordance with the herein described exemplary embodiments the body 24 of the vehicle 12 may carry a number of components of the power system 10, which is shown schematically. When on the vehicle 12, the components are referred to as being onboard. The power system 10 may employ an onboard charging system topology that may be compatible with a variety of charging system variations. In a number of examples, functions of the power system 10, may be executed in the electronic control system 28 of FIG. 1, which may be electrically coupled with the power system 10. In other examples, functions of the power system 10 may be executed in other controllers outside the electronic control system 28.

When charging of the ESS 14 is desired, the vehicle 12 and the power source 54 may be brought in proximity with one another to enable connection, such as through a cable connection 52 and/or inductive coupling (not depicted). The charging process may be controlled through the power system 10, which for example, may include any, or any combination of: surge protection; filtering; converting between alternating current (AC), and direct current (DC); power factor correction (PFC); and/or DC-DC buck or boost conversion. In a number of examples, charging may be controlled to provide multiple stages with different current and/or voltage modes. System protections such as isolation may be provided through the power system 10. Accordingly, in a number of examples the power system 10 may provide onboard control of a number of factors in the charging process when power is received from the power source 54 and delivered to the ESS 14.

The power source 54 may be of a type normally available in a residence, such as a 120V, or 240V, 60 Hz supply, with ground. The AC voltage may be received onboard the vehicle 12 through a protective device such as a surge protector 60 to provide protection from voltage variation in the supply. The AC voltage may be conducted from the surge protector 60 to a filter 62, which may reduce the transfer of electromagnetic noise. The AC circuit may continue from the filter 62 to a rectifier 64, where the AC voltage may be converted to DC. The rectifier 64 may include any suitable rectifying arrangement such as diodes, silicon-controlled rectifiers (SCRs), or insulated gate bipolar transistors (IGBTs), connected in a bridge configuration. On the opposite side of the rectifier 64 from the filter 62, a DC bus 66 begins. The DC bus 66 includes DC bus rails 68, 70.

A converter 72 may be connected in the DC bus 66 adjacent the rectifier 64. The converter 72 may may be an N-phase, transformer-less converter to provide stepped up (boosted) DC electric power to charge a DC link capacitor 76 coupled to the DC bus 66 between rails 68 and 70. The converter include switches 78, 80 and 82. The switches 78, 80 and 92 may include a semiconductor device such as a metal oxide semiconductor field-effect transistor (MOSFET), installed gate, bipolar transistor (IGBT), gate turn-off thyristor (GTO), or another electronic switching device as the switching element. The switches 78, 80 and 82 may be provided with antiparallel diodes. The switches 74, 76 and 78 are controllable for conducting (ON), and blocking (OFF), modes. The switch 74 may be connected in the DC bus rail 68 to provide on-off control. The converter 72 may furthermore include a plurality, N, of interleaved inductor stages 74 and two interleaved inductor stages 84 and 86 are depicted. The inductor stage 84 includes an inductor 88, a diode 90 and switch 80. The inductor stage 86 includes an inductor 92, a diode 94 and switch 82.

The DC link capacitor 76 may be charged from the power source 54 through the converter 72. The converter 72 may be electrically coupled with a controller and gate driver 96. The controller 96 may be powered by a low voltage source 100. The controller and gate driver 96 is operable to provide a drive input for the gates of the semiconductor devices of switches 78, 80 and 82. The controller 96 provides switching control for the converter 72 controlling the switches 78, 80 and 82 according to control logic that may be programmed to provide the desired output, and for responses to operation modes, voltage status, and other factors. While the converter 72 employs an N-phase, transformer-less converter structure, other converter topologies may be employed in the power system 10, such as inductor-capacitor (LC) networks.

In exemplary embodiments, a second converter 100 may be connected in the DC bus 66 between the DC link capacitor 76 and the ESS 14. The converter 100 includes a unidirectional boost converter 102 and a unidirectional buck converter 104 arranged in an interleaved configuration 106. It will be appreciated additional boost and/or buck converters may be provide within the interleaved configuration 106. The converter 100 includes a switch 108 disposed within the DC rail 68.

The boost converter 102 includes a switch 110, an inductor 112 and a switch 114. The buck converter 104 includes a switch 116, an inductor 118 and a switch 120. A link capacitor 122 is provided within the converter 100 between the DC rail 68 and the DC rail 70. The switches 108, 110, 114, 116 and 120 may include a semiconductor device such as a metal oxide semiconductor field-effect transistor (MOSFET), insulated gate bipolar transistor (IGBT), gate turn-off thyristor (GTO), or another electronic switching device as the switching element and may be provided with antiparallel diodes. The switches 108, 110, 114, 116 and 120 may furthermore be controllable for conducting (ON), and blocking (OFF), modes.

The converter 100 may be electrically coupled with a controller and gate driver 122. The controller 122 may be powered by the low voltage source 100. The controller and gate driver 122 is operable to provide a drive input for the gates of the semiconductor devices of switches 108, 110, 114, 116 and 120. The controller 122 provides switching control for the converter 100 controlling the switches 108, 110, 114, 116 and 120 according to control logic that may be programmed to provide the desired output, and for responses to operation modes, voltage status, and other factors.

The ESS 14 is connected to the DC bus 66 through an isolation solenoid switch 124. Also, optionally connected to the DC bus 66, is a power module 126 that provides the low voltage source 132 and low voltage DC electric power to various low voltage loads 128 within the vehicle 12.

One or more motor control modules 130 couple to the DC bus 66 at the link capacitor 76. Additional high voltage (in excess of approximately 15 volts DC) components 132 may be coupled to the DC bus 66. The motor control modules 130 are operable in a known manner to provide driving DC or AC electric power to the motor 36 responsive to the voltage on the DC bus 66 at the link capacitor 76 and in response to control signals from one or more the electronic controls 28.

The interleaved configuration 106 of the converters 102 and 104 within the second converter 100 may depend on the voltage rating of the ESS 14 relative to the DC bus voltage at the link capacitor 76 and the configuration of the propulsion system 16 including the motor 36. The converter 100 may be either a buck or a boost converter depending on the voltage rating of the ESS 14 and the voltage delivered by the converter 72. For example, the converter 100 may be configured as a buck converter, constructed to provide a step down (buck) in voltage when the ESS 14 voltage is lower than the voltage output from the converter 72. Alternatively, the converter 100 may be a boost converter, constructed to provide a step up (boost) in voltage from the ESS 14 to correspond to the higher voltage output of the converter 72 and the voltage on the DC bus at the link capacitor 76. It will be appreciated in alternative arrangements, should the ESS 14 voltage by higher than the output of the converter 72, the converter 100 may be configured as a boost converter to provide a step up in voltage from the converter 72 to the ESS 14 for charging, and as a buck converter to provide a step down in voltage from the ESS 14 to the DC bus at the link capacitor 76.

Responsive to signals provided by controllers 96 and 122, during operation of the power system 10 to charge the link capacitor 76, the switch 108 may be set to OFF (open) to disconnect the converter 100, and hence the ESS 14, from the DC bus 66 including the link capacitor 76 and the power source 54. The converter 72 coupled to the source 54 appropriately steps up the voltage to the target voltage for the DC bus 66 at the link capacitor 76 effectively charging the link capacitor 76. The switch 108 may be set to the ON (closed) state to connect the converter 100, and hence the ESS 114, to the DC bus 66 and power source 54. In a charging operating mode, DC power is coupled by the converter 100 to the ESS 14, and in a propulsion mode, DC power is coupled by the converter 100 from the ESS 14 to the link capacitor 76.

The converter 100 is operable through arrangement of the switches 108, 110, 114, 116 and 120 to provide stepped up voltage from the ESS 14 to the link capacitor 76 or stepped down voltage from the link capacitor 76 to the ESS 14, and vice versa as the case may be. In one exemplary embodiment, the ESS voltage 14 is less than the voltage of the DC bus 66 at the link capacitor 76. During propulsion mode, both converters 102 and 104 are interleaved together to create (boost) a higher rated step-up converter to boost the voltage from the ESS 14, e.g., V2=350V, to a higher voltage, e.g., V1=600V. During charging mode, both converters 102 and 104 are interleaved to step-down (buck) the voltage, e.g., V1=600V, to the ESS 14 voltage, e.g., V2=350V.

Interleaving the converters 102 and 104 enhances the ripple performance and hence simplifies the design of the converter 100. The input and output inductors 112 neither 118 (boost and buck respectively) are optimized for interleaved and bidirectional operation. The converter 100 furthermore provides transformer-less isolation via solid state, semiconductor switches 110, 114, 116 and 120. As a further advantage, an arrangement of a power system 10 in accordance with the exemplary embodiments enables coupling of the motor control modules 130 to DC bus 76 at the DC link capacitor 76 between the converter 72 and the converter 100.

Through the foregoing examples, a power system arrange with reduced component count and system mass allows for converter optimization around the ESS and link capacitor design. While examples have been presented in the foregoing detailed description, it should be appreciated that a vast number of variations exist. It should also be appreciated that details are only examples, and are not intended to limit the disclosure's scope, applicability, or configurations, in any way. Rather, the foregoing detailed description will provide those skilled in the art with a convenient road map for implementing examples of the invention. It being understood that various changes may be made in the function and arrangement of elements described in examples without departing from the scope as set forth in the appended claims.

What is claimed is:

1. A power system configured to deliver direct current (DC) electric power to an energy storage system (ESS) at a first voltage and to deliver DC electric power from the ESS at a second voltage, different than the first voltage, the system comprising:
a converter operably coupled to an electric power source at the second voltage, the converter comprising:
a boost converter and a buck converter, the boost converter and the buck converter being configurable in a first interleaved arrangement via the selective configuration of at least one switch associated with the boost converter and the buck converter, and in a second interleaved arrangement, different than the first interleaved arrangement, via the selective configuration of the at least one switch, and wherein,
in the first interleaved arrangement the converter provides DC electric power from the power source to the ESS at the first voltage, and in the second interleaved arrangement the converter provides DC electric power from the ESS to a load at the second voltage.

2. The power system of claim 1, wherein each of the boost converter and the buck converter comprises, operably coupled, an inductor and a semiconductor switch.

3. The power system of claim 1, wherein the at least one switch comprises a semiconductor switch.

4. The power system of claim 1, further comprising a second converter operably disposed between the power source and the converter, the second converter having a DC electric output at the second voltage.

5. The power system of claim 4, the power source being an alternating current (AC) electric power source.

6. The power system of claim 4, a link capacitor disposed between the converter and the second converter, and the load comprises a propulsion system including at least one electric motor being coupled to the link capacitor.

7. The power system of claim 1, each of the boost converter and the buck converter being unidirectional.

8. The power system of claim 1, the converter comprising a plurality of boost converters and a plurality of buck converters, the plurality of boost and buck converters being configurable into the first interleaved arrangement and the second interleaved arrangement.

9. The power system of claim 1, the first voltage being less than the second voltage, the first interleaved arrangement providing a stepped down voltage from the power source to the ESS, and the second interleaved arrangement providing a stepped up voltage from the ESS to the load.

10. The power system of claim 1, the power system being configured to provide driving electric power to an electric propulsion system of a vehicle.

11. A vehicle comprising power system, the power system configured to deliver direct current (DC) electric power to an energy storage system (ESS) at a first voltage and to deliver DC electric power from the ESS at a second voltage, different than the first voltage, to a propulsion system of the vehicle, the system comprising:
a converter operably coupled to an electric power source at the second voltage, the converter comprising:
a boost converter and a buck converter, the boost converter and the buck converter being configurable in a first interleaved arrangement via the selective configuration of at least one switch associated with the boost converter and the buck converter, and in a second interleaved arrangement, different than the first interleaved arrangement, via the selective configuration of the at least one switch, and wherein,
in the first interleaved arrangement the converter provides DC electric power from the power source to the ESS at the first voltage, and in the second interleaved arrangement the converter provides DC electric power from the ESS to the propulsion system of the vehicle at the second voltage.

12. The system of claim 11, the ESS comprising a battery storage system disposed on the vehicle.

13. The system of claim 11, the propulsion system comprising at least one electric motor.

14. The system of claim 11, wherein each of the boost converter and the buck converter comprises, operably coupled, an inductor and a semiconductor switch.

15. The system of claim 11, wherein the at least one switch comprises a semiconductor switch.

16. The system of claim 11, further comprising a second converter operably disposed between the power source and the converter, the second converter having a DC electric output at the second voltage.

17. The system of claim 16, the power source being an alternating current (AC) electric power source.

18. The system of claim 18, the propulsion system being coupled between the converter and the second converter.

19. The system of claim 1, the converter comprising a plurality of boost converters and a plurality of buck converters, the plurality of boost and buck converters being configurable into the first interleaved arrangement and the second interleaved arrangement.

20. The power system of claim 1, the first voltage being less than the second voltage, the first interleaved arrangement providing a stepped down voltage from the power source to the ESS, and the second interleaved arrangement providing a stepped up voltage from the ESS to the propulsion system.
